(19) United States
(12) Patent Application Publication
(10) Pub. No.: US 2017/0157723 A1
(43) Pub. Date: Jun. 8, 2017

(54) Method for production of a heat exchanger with at least two fluid circulation circuits with a large number of channels and/or large dimensions

(71) Applicant: COMMISSARIAT A L'ENERGIE ATOMIQUE ET AUX ENERGIES ALTERNATIVES, Paris (FR)

(72) Inventors: Isabelle MORO-LE-GALL, FONTAINE (FR); Julien CIGNA, VILLARS DE LANS (FR); Emmanuel RIGAL, SASSEANGE (FR)

(73) Assignee: COMMISSARIAT A L'ENERGIE ATOMIQUE ET AUX ENERGIES ALTERNATIVES, Paris (FR)

(21) Appl. No.: 15/370,448

(22) Filed: Dec. 6, 2016

(30) Foreign Application Priority Data
Dec. 7, 2015 (FR) 15 61906

(51) Int. Cl. B23P 15/26; F28D 9/00

(52) U.S. Cl. CPC B23P 15/26; F28D 9/0093

(57) ABSTRACT

A method for fabrication of heat exchangers with at least two fluid circuits each one comprising channels based on grooved plates includes assembling elementary exchanger modules, each of the elementary exchanger modules having been produced by diffusion bonding of grooved plates.

### TECHNICAL FIELD

The present invention concerns heat exchangers with at least two fluid circuits each one comprising channels.

More particularly, the invention deals with a new method of fabrication to obtain such exchangers with a large number of channels and/or large dimensions.

The known heat exchangers comprise either one or at least two circuits having internal fluid circulation channels. In the exchangers with only one circuit, the heat transfers occur between the circuit and a surrounding fluid in which it is bathed. In the exchangers with at least two fluid circuits, the heat transfers occur between the two fluid circuits.

Chemical reactors are known which carry out a continuous process whereby a slight quantity of co-reactants is injected simultaneously, at the inlet of a first fluid circuit, preferably outfitted with a mixer, and the resulting chemical product is recovered at the exit from said first circuit. Among these known chemical reactors, certain of them comprise a second fluid circuit, usually called a utility circuit, and whose function is to thermally control the chemical reaction, either by providing the necessary heat for the reaction or on the contrary by removing the heat liberated by it. Such chemical reactors with two fluid circuits with utility are usually called exchanger reactors.

The present invention involves both the realization of heat exchangers with solely a heat transfer function and the realization of exchanger reactors. Also, by “heat exchanger with at least two fluid circuits” is meant in the context of the invention both a heat exchanger with solely a heat transfer function and an exchanger reactor.

### BACKGROUND

The existing plate-type heat exchangers have major advantages over the existing tube-type heat exchangers, particularly their thermal performance and their compactness thanks to a favorably increased ratio of surface to volume of heat transfers.

The known tube-type exchangers are, for example, shell and tube exchangers, in which a bundle of straight or U-shaped or helically shaped tubes is fixed to perforated plates arranged inside a compartment known as the shell. In these shell and tube exchangers, one of the fluids circulates inside the tubes while the other fluid circulates inside the shell. These shell and tube exchangers have a substantial volume and are thus not very compact.

The known plate exchangers are more compact and are obtained by stacking of plates comprising channels and assembled to each other.

In the same way, so-called plate-type reactor exchangers have as their advantage a highly compact design and elevated cooling and therefore thermal control capabilities during the chemical reactions. These reactions are in fact often exothermal, and it is necessary to limit the temperature rise in the reactant channels, i.e., where the chemical reaction occurs, in order to control the reaction from a thermal standpoint, and also limit the thermal aging of the catalysts sometimes present in the reactant channels.

In any case, the channels are generally made by punching out of plates, if necessary by addition of folded strips in the form of fins or by machining of grooves. The machining is done by mechanical means, for example, by milling or by chemical technique. The chemical machining is usually called chemical or electrochemical etching.

The purpose of the assembly of the plates to each other is to ensure the tightness and/or mechanical strength of the exchangers, particularly the resistance to the pressure of the fluids circulating inside them. The assembly process generally involves a stacking done by placing plates of several types one on top of another in a regularly repeating sequence, each type corresponding to one of the fluid circuits, and the stack might contain nongrooved separation plates.

Several assembly techniques are known and used depending on the type of plate exchanger desired. Thus, the assembly may be produced by mechanical means, such as tie rods holding the stack clamped between two thick and rigid plates arranged at the ends. The tightness of the channels is then obtained by flattening of attached seals. The assembly may likewise be produced by welding, generally limited to the periphery of the plates, which sometimes requires inserting the exchanger after the welding inside a shell to allow it to withstand the pressure of the fluids. Again, the assembly may be produced by brazing, in particular for exchangers having fins added on. Finally, the assembly can be done by diffusion welding (diffusion bonding).

The latter two techniques mentioned allow exchangers of particularly good performance in terms of mechanical strength to be produced. In fact, thanks to these two techniques, the assembly is produced not only at the periphery of the plates, but also inside the exchanger.

The plate-type heat exchangers assembled by diffusion welding have even stronger mechanical joints than the joints of exchangers obtained by brazing due to the absence of the added metal required for the brazing.

Diffusion bonding consists in obtaining a solid state assembly by applying a force in the hot state to the pieces being assembled for a given time. The force applied has a dual function: it enables a docking, that is, a contacting of the surfaces being welded, and facilitates the elimination of the residual porosity in the joints (interfaces) by diffusion flow.

The force may be applied by uniaxial compression, for example with the aid of a press outfitted with a furnace or simply with the aid of weights arranged at the top of the stack of pieces being assembled. This method is commonly called uniaxial diffusion bonding and it is employed industrially in the manufacture of plate-type heat exchangers.

One major limitation of the uniaxial diffusion bonding process involves the fact that it is not able to weld joints of any given orientation with regard to the direction of application of the uniaxial compression force.

Another alternative process mitigates this drawback. In this other process, the force is applied via a gas under pressure in a tight enclosure. This method is commonly known as Hot Isostatic Compression (HIC). Another advantage of the diffusion bonding method by HIC as compared to the uniaxial diffusion bonding method is that it is more widely used on an industrial scale. In fact, HIC is also used for the processing of batches of foundry pieces as well as for the compaction of powders.

The currently known compact plate exchangers obtained by diffusion welding also have drawbacks which can be listed as follows.

A first drawback is the cost of fabrication of the plates, particularly in the case of plates with machined channels. To be sure, chemical etching allows a certain cost reduction as compared to mechanical machining, but this is entirely relative: in fact, adjusted to a given length, the cost of a channel of a plate exchanger made by chemical etching is higher than that of a tube exchanger. Moreover, chemical etching has many drawbacks, such as an insufficient dimensional precision, a rounding of the edges which is unfavorable to diffusion welding or a residual contamination of the surfaces being assembled with residues of the pickling and masking products used.

The second drawback of plate exchangers is the importance of obtaining an optimal tightness for each fluid circuit with respect to the other circuits and to the surroundings of the exchanger, primarily for reasons of safety. Consequently, the fabrication of such an exchanger most of the time requires a surface condition of the plates nearly free of all defects. Defects initially present on the surface of the plates prior to fabrication of the exchanger may remain after fabrication and thus allow a possible leakage of one of the fluids. Prior to fabrication, long and tedious surface inspections of each metal sheet are then necessary to detect these defects, and many plates may have to be rejected if necessary. What is more, the checking of the tightness of the heat exchanger with at least two fluid circuits after fabrication is difficult to carry out with the current techniques. All of these inspection operations coupled with the rejecting of plates having defects may generate substantial surplus costs.

Another drawback of compact plate exchangers welded by diffusion is the difficulty of finding a good compromise between the mechanical strength of the resulting interface joints, the acceptable deformation of the channels, and the grain enlargement of the material of the structure.

In fact, in the uniaxial diffusion bonding process, one can apply a force of slight or even very slight value causing little deformation to the channels, provided that the plates are in good mutual contact and the slight value of the force is compensated by an increase in the welding temperature to eliminate the porosity at the interfaces. These conditions inevitably lead to a grain enlargement of the material, which may become prohibitive in regard to its corrosion resistance and its mechanical properties. Moreover, in many applications it is critical for the number of material grains situated between two fluid circuits to exceed a minimum value in order to avoid risks of leakage.

This problem of finding a good compromise is more critical and important as the size of the reactor and/or the number of reactor channels increases.

In the method of diffusion bonding by HIC, the stack of pieces is first encapsulated in a tight container to prevent the gas from penetrating into the interfaces comprised of the surfaces being bonded. The gas pressure normally used is elevated, in the order of 500 to 2000 bar, typically 1000 bar. The minimum operating pressure of the industrial enclosures adapted to carry out the HIC is for its part between 40 and 100 bar. Now, the joints bonded at this pressure are not as strong as those obtained at higher pressure, for example, at 1000 bar, all other conditions being equal (material, temperature, surface condition, etc.). What is more, this pressure between 40 and 100 bar is still too large for plates with a high density of channels, that is, plates whose defined contact surface with an adjacent plate is small in relation to the total apparent surface. In fact, for this type of plate, even a pressure of several dozen bars may be enough to cause an unacceptable deformation of the channels.

One possible solution may involve decreasing the temperature of the assembly process so that the material is better resistant to the pressure, but this ends up with further degrading of the strength of the joints.

Another possible solution may be to change the design of the channels to make the stack more resistant to pressure, but this ends up with making the plate exchanger less compact.

Finally, one possible solution is, after having welded the exchanger by diffusion at low pressure, to open the channels and subject it to a cycle of HIC at high pressure, in order to finish the assembly process. This solution only works if the quality of welding during the first assembly process is sufficiently good and tight interfaces have been obtained.

It should be noted that the transmission of the bonding force in a stack of grooved plates occurs in an unequal manner, whether it involves the method of uniaxial diffusion bonding or the method of diffusion bonding by HIC. In fact, the portions of the interfaces situated beneath the grooves are subjected to a reduced bonding force, as this is only transmitted by the two ribs, or isthmuses, located on either side of each groove. Conversely, an elevated bonding force is obtained opposite the ribs. The quality of the interfaces may thus vary from one place to another in the stack. FIG. 1 represents a stack of four grooved plates 11, 12, 13, 14 undergoing a diffusion bonding in order to assemble them together. As symbolized in this figure, the quality of transmission of the bonding force at the interface 110 between the two plates 12, 13 varies as a function of the different zones, whether opposite the ribs or isthmuses or not.

Moreover, this heterogeneity of transmission of the bonding force during the fabrication of these heat exchangers may result in a heterogeneous deformation of the assembly at the end of the fabrication process, the largest deformation occurring in the zones having undergone the largest forces, and vice versa. In the particular case of manufacturing an exchanger reactor, this difference in final geometry between the reactant channels is potentially very troublesome. In fact, it results in a difference in gas flow rate between the reactant channels, and thus in a heterogeneous wear on the catalysts in the different channels. This may lead to the appearance of hot spots and thus result in a reactor with unstable and unpredictable thermal behavior, which fatally leads to a low efficiency of the reactor and/or a premature deactivation of the catalyst.

It is possible to reduce the deformation by decreasing the temperature of the assembly process so that the material has a better mechanical strength. However, this comes down to a degrading of the strength of the joints obtained after the diffusion bonding.

Another possible solution may involve changing the geometry of the channels by decreasing the dimensions of the channels and/or increasing the dimensions of the isthmuses between channels in order to make the stack more resistant to the pressure, but this results in making the plate exchanger less compact.

Since the deformation also depends on the width of the borders, which are the nongrooved zones situated laterally on either side of the grooved zone, and the thickness of the anvils, which are the nongrooved zones situated at the top and bottom ends of the stack, another solution for diminishing the deformation consists in making these zones thicker. This thickening should be larger in relation to the extent to which the exchanger is of larger size.

However, the available HIC enclosures have limited dimensions: for exchangers of large size, one quickly reaches the limits of the equipment by increasing the dimensions of the isthmuses or the lateral borders of the exchangers.

What is more, when it is necessary to handle a substantial volume of fluid, and thus multiply the number of reactant channels, it is always easier to have a single reactor of large size rather than placing several reactors of more reduced size in parallel. In fact, on the one hand, it is difficult to perfectly balance the flow rates among the different reactors, and thus there may be premature wear on the catalyst present in certain of the reactors as compared to others, and on the other hand the fluidized parallel connection of several reactors necessarily presupposes a multiplying of pipelines, valves, and other distribution and regulation components. The result is an increased price of the installation, as well as a substantial loss of compactness of the final installation.

Now, if one wishes to fabricate plate reactors to be assembled by diffusion bonding, this is especially due to the fact that they are clearly more compact than classical tube reactors, as mentioned at the outset.

From this standpoint of maintaining a maximum compactness of the exchanger and of the entire system, the placement of borders of significant dimensions and/or the insertion in the reactor of solid plates enabling a better mechanical resistance to pressure at high temperature (and thus less deformation) during the welding should be avoided, since this will fatally result in reduced compactness of the reactor.

Finally, it is not possible to increase significantly the number of plates in order to increase the number of channels in the exchanger. In fact, if for example at given pressure and temperature during an HIC assembly process the height of the channels at the center of the stack decreases, for example by 10% at the end of the assembly cycle, then the larger the number of channels in the height of the reactor, the more the total slump in the height of the reactor. As a result, the deformation of the corner channels increases with the number of channels stacked.

This is diagrammed in FIGS. 2A and 2B which show, in cross section and for a quarter of a stack, the deformations calculated for two geometries (of identical dimensions but different numbers of plates) subjected to the same HIC cycle. It may be observed that:
the slumping of the height of the exchanger 1 of FIG. 2A is greater than that of FIG. 2B which has a lower number of channels 2 in the height;
the corner channels 2′ are more deformed in the exchanger of FIG. 2A than in that of FIG. 2B.

Thus far, when fabricating exchangers of large dimensions and/or with a large number of channels, in order to further increase their compactness an attempt will be made to reduce the dimensions of the channels, those of the isthmuses and the borders. All of these trends run in the direction of increasing of the deformation of the channels during the HIC assembly process.

Thus, there is a need to further improve the methods of producing heat exchangers of large dimensions and/or with a large number of channels, especially in order to limit the deformation of the channels during the assembly process of the plates making up said exchangers, and this without degrading the interfaces between plates or harming the compactness of the exchangers.

The purpose of the invention is to meet this need at least in part.

### SUMMARY

To accomplish this, the invention concerns a method of production of a heat exchanger with at least two fluid circuits each one comprising channels, involving the following steps:

a/ production of at least two elementary modules of the exchanger, the production of each elementary module involving the following steps:

i/ production of one or more elements of one of the two fluid circuits, the so-called first circuit, each element of the first circuit comprising at least one metal plate comprising first grooves forming at least one portion of the channels of the first circuit;

ii/ production of one or more elements of at least one other fluid circuit, the so-called second circuit, each element of the second circuit comprising at least one metal plate comprising second grooves forming at least one portion of the channels of the second circuit;

iii/ stacking of the metal plates of the elements of the first and second circuits in order to form their channels;

iv/ assembling by diffusion bonding of the element or elements of the first circuit and the element or elements of the second circuit, stacked one on the other;

b/ modification of at least one of the elementary modules involving a reduction of the width of at least one of the borders and/or of the thickness of at least one of the anvils of at least one of the modules and optionally an opening of the channels of the first circuit and/or of the second circuit to the outside;
c/ edge to edge positioning of the elementary modules, at least one of which is reduced, along one of their longitudinal edges or one of their lateral edges;
d/ assembling of the interfaces between the edge to edge elementary modules in order to obtain the exchanger in one-piece form.

Thus, the invention consists in assembling elementary modules of exchangers each of which has itself been previously produced by diffusion bonding of grooved plates.

For each elementary module of the exchanger, substantial lateral borders can be utilized, optionally in the form of nongrooved edges in the plates or in the form of independent tools added in the container. The result is an increased bearing surface, and thus a reduced overall stress experienced by the material, and consequently a decrease in the final deformation.

Likewise, substantial anvils can be used at the start and end of the stack of at least one of the elementary modules, optionally in the form of supplemental nongrooved plates or in the form of independent tools added in the container. The result is an increased rigidity of the stack, which prevents its deformation facing the grooved zone during the HIC cycle.

Once these elementary modules have been assembled by diffusion bonding, the excess material represented by the anvils and the borders is eliminated at least in part and the resulting so-called reduced module(s) are assembled together. This step b/ of modification with at least a reduction of dimensions of at least one of the elementary modules makes it possible to improve the compactness of the elementary modules.

One thus obtains a single-piece exchanger which may have large dimensions and/or a large number of channels, which could not have been achieved at one go according to the methods of the prior art because these large dimensions and/or large number of channels would have produced an excessive deformation in the area of the channels after the assembly by diffusion bonding.

In step a/, preferably before the stacking, that is, before step iii/, one may advantageously perform a step i1/ and ii1/ of cleaning of the plates of each element respectively of the first circuit and second circuit. The cleaning may be done, for example, with the aid of detergents or solvents.

According to one advantageous embodiment, one performs step iv/ by application of a hot isostatic compression (HIC) cycle at relatively low pressure to the tight and degassed stack. This HIC cycle is designated here at relatively low pressure, since the pressures are lower than those of a HIC cycle designated at high pressure, i.e., between 500 and 2000 bar, advantageously between 800 and 1200 bar.

The cycle of HIC type involves a heating and a pressurization, most often simultaneous, a temperature and pressure plateau, then a cooling and a depressurization. This cycle is chosen in particular as a function of the material(s) of the plates making up the elements of the first and second circuit. In particular, one may choose the plateau temperature and the rates of heating and pressurization (or respectively cooling and depressurization) especially by taking account of the capabilities of the HIC enclosure being used.

Thus, preferably the cycle of HIC per step iv/ is realized according to the following characteristics, taken alone or in combination:
at a pressure between 20 and 500 bar, preferably between 30 and 300 bar; the choice of the pressure results from a compromise between quality of weld being produced and acceptable deformation of the channels;
at a temperature between ambient temperature and 1100° C., preferably between 900 and 1100° C.; the temperature used depends on the material making up the plates used, the maximum allowable grain size, and the desired quality of the joint;
for a period between 15 min and several hours, preferably between 1 and 4 h; the heating and pressurization times (or cooling and depressurization times) depend on the characteristics and possibilities of the equipment (enclosure) used, they are normally several hours.

According to a first variant, prior to this low-pressure HIC cycle one can perform a step of sealing the periphery of the at least two metal plates of each element, after which one performs a step of degassing of the interior of each tight stack through an orifice emerging onto each interface between plates, and a step of closure of the emerging orifice. The degassing of the channels and of the interface or interfaces is done by placing under a vacuum, through the emerging orifice, after which the latter is blocked.

Alternatively, one can perform the insertion of each stack in a metal envelope, a so-called container, and then a step of welding of the container, which has an emerging orifice, opposite which there is welded a tube, the so-called pip, a step of degassing through the pip, and then a welding of the pip. To accomplish the degassing, this pip is connected to a vacuum pump, the pumping is done at a given temperature, between ambient temperature and around 400° C., then the pip is blocked by welding, without letting in air. The length of the pumping will be a function of the desired quality of vacuum.

During step b/, the reduction of the width of at least one of the borders and/or the thickness of at least one of the anvils of at least one of the modules can be accomplished by removing the tools by demolding or machining, or by machining the nongrooved borders of the plates and/or the anvils. The opening of the channels can be accomplished by machining of the ends of the module or a bore opposite to the channels.

Step c/ of edge to edge positioning may consist of one or other of the following variants:
a stacking of the elementary modules by the principal faces of the end plates of the modules;
an edge to edge alignment along the length of the elementary modules;
a positioning of a lateral edge of one of the elementary modules against a lateral edge of the other of the elementary modules.

This step c/ can make use of alignment pins or any other means adapted to ensuring a correct positioning of the reduced modules so as to establish the desired final geometry, in particular to establish the continuity of the fluid circuit or circuits.

Step d/ may be accomplished, for example, by electron beam welding, brazing, or diffusion bonding of the reduced modules between themselves. According to a preferred embodiment, this step d/ consists of a diffusion bonding by HIC. In this case, it is carried out with the following steps:
cleaning of the surfaces of the reduced elementary modules with the aid of solvents and/or detergents, for example,
sealing of the periphery of the interfaces of the reduced elementary modules, for example, by welding or by inserting them into a welded container,
degassing of the interfaces between the elementary modules, including the reduced ones, for example with the aid of one or more pips welded opposite one or more orifices emerging onto the interfaces or one or more pips welded opposite one or more orifices made in the wall of the container, the pip(s) being welded tight at the end of the degassing,
application of at least one hot isostatic compression cycle.

Moreover, according to another preferred embodiment, the diffusion bonding of the reduced elementary modules is performed during the high-pressure cycle making it possible to finish the welding of the internal interfaces of the elementary modules. This method causes only slight additional expense, basically involving the production of the seals between the elementary modules, for example, by means of peripheral welds. For this, step b/ involves an opening of the channels of the first circuit and/or of the second circuit. When it is possible to open the two fluid circuits, a single high-pressure HIC cycle may be applied. When the positioning of the reduced elementary modules at the end of step c/ only allows the opening of a single circuit, which is the case when the other circuit empties into the interfaces between reduced elementary modules, the pressure of the HIC cycle should be limited so as not to deform the closed circuit. In this case, one can open the latter at the end of this HIC cycle and apply a second cycle with the two circuits open in order to complete the assembly of the exchanger.

In this embodiment, the transmission of the welding force is done by the gas pressure not only at the interfaces between elementary modules but also by the inside of the channels of each of the modules. Thus, the welding force is particularly well distributed and the welding together of the elementary modules is assured.

The invention thus makes it possible to fabricate exchangers with many channels and/or with large dimensions, while achieving a good compactness for both the one-piece exchanger and for the overall final system and minimizing the excess expense as compared to the methods of the prior art, because at most only a single supplemental diffusion bonding step is needed.

An elementary module may comprise plates of different materials or all plates made from the same material, such as a stainless steel of type 316L.

The material or materials making up an elementary module may be identical to or different from that or those of another elementary module.

The method according to the invention can preferably include a step e/ of final machining to finish the one-piece exchanger.

The invention likewise deals with a heat exchanger with at least two fluid circuits obtained by the method as described above.

The invention is advantageously utilized for a fabrication of exchangers at low industrial cost with no stringent thermohydraulic requirements, yet with high criticality for their tightness, such as can be found in exchanger reactors.

### BRIEF DESCRIPTION OF DRAWINGS

Other advantages and characteristics of the invention will be more evident from a perusal of the detailed description of sample embodiments of the invention, given as an illustration and not a limitation, with reference to the following figures, among which:

FIG. 1 is a cross-sectional view of an exchanger module according to the prior art, produced by HIC, showing the different zones of transmission of the welding force;

FIGS. 2A and 2B are schematic cross-sectional views of exchanger modules according to the prior art, produced by HIC during the same HIC cycle, respectively of greater and lesser stack height, showing the deformation of the channels of one of the fluid circuits as well as the slumping of the height of the modules;

FIGS. 3A, 3B and 3C are perspective views of a metal plate adapted to produce an elementary exchanger module according to the invention, respectively before the producing of grooves forming a portion of the fluid channels, with the grooves of one of the circuits at one of its principal faces and with the grooves of the other of the circuits at the other of its principal faces;

FIG. 4 is a perspective view of a sample elementary exchanger module according to the invention obtained by diffusion bonding assembly of grooved and stacked plates, before the step of opening of the channels;

FIG. 4A is a transverse and longitudinal section view of the stack of the elementary module per FIG. 4;

FIGS. 5, 6 and 7 are perspective views of three elementary exchanger modules produced according to the invention, prior to their mutual assembly in order to form a one-piece exchanger according to the invention;

FIG. 8 is a perspective view of a sample one-piece exchanger according to the invention produced by edge to edge positioning and then diffusion bonding assembly of the three elementary modules per FIGS. 5 to 7;

FIG. 8A is a cross-sectional view of the module per FIG. 8, showing the bores produced during the machining of the plates of the elementary modules, some of which enable the connecting of the different zones of the elementary modules positioned edge to edge and others enable the placing under vacuum of the interfaces to be welded between the elementary modules positioned edge to edge.

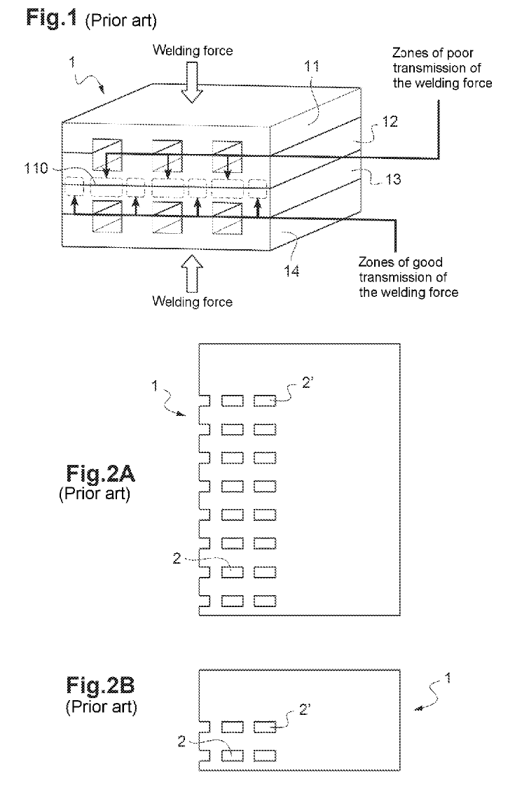

### DESCRIPTION OF EXEMPLARY EMBODIMENTS

The terms “longitudinal” and “lateral” are to be considered in relation to the geometrical shape of the metallic plates which determine the geometrical shape of the stacks of the heat exchanger module according to the invention. Thus, in the end the four longitudinal sides of the stack of an elementary exchanger module according to the invention are those extending parallel to the longitudinal axis X of the plates, that is, along their length. The two lateral sides of the stack are those extending along the lateral axis Y of the plates, orthogonally to the axis X, that is, along their width.

The terms “on top” and “at bottom” should be considered in relation to the direction of the stacking of the exchanger module. Thus, the plate on top, forming all or part of an anvil, is the last plate stacked on top of the others.

Step a/:

First of all, one produces in the same manner a number of several elementary exchanger modules which may be of different dimensions.

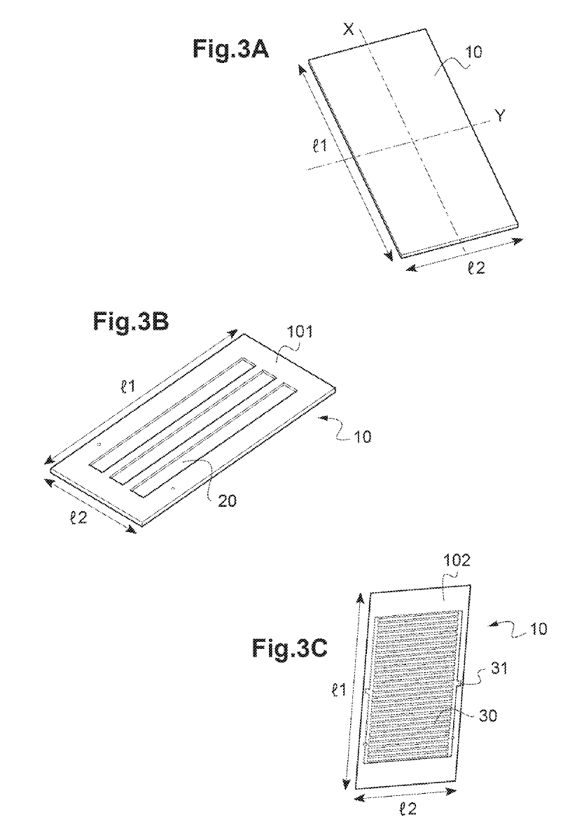

We shall describe the production by the first step a/ of an elementary module 1.1 from metal plates 10, such as plates of stainless steel of type 316L, with length l1 and width l2 (FIG. 3A). The borders and the anvils of the plates 10 are advantageously dimensioned such that the deformations are controlled during an assembly by HIC diffusion bonding.

Step i/: in order to produce an element of a first fluid circuit C1, one machines in one of the principal faces 101 of a metal plate 10 grooves 20 which are straight and parallel to the length l1 of the plate in the example illustrated (FIG. 3B).

Step ii/: in order to produce an element of a second fluid circuit C2, one machines in the other of the principal faces 102 of a metal plate 10 grooves 30 which are straight and parallel to the width of the plate in the example illustrated (FIG. 3C).

The grooves 20, 30 can be produced by any adapted means: machining, chemical etching, stamping, etc.

One then produces, as usual, the necessary attached pieces for the producing of the stack of grooved plates 10 and their assembly (tools). This may involve, in particular, alignment pins, holding tools (uniaxial diffusion bonding), optionally a container if the stack of plates is assembled by HIC diffusion bonding.

Steps i1/ and ii1/: cleaning is carried out with the aid of solvents and detergents of the plates 10.

Step iii/: after having cleaned them, one stacks the assemblage of plates 10 so as to form both the channel elements 2 of the first circuit C1 and the channel elements 3 of the second circuit C2.

During the stacking, all the plates 1 are aligned in relation to each other thanks to the alignment pins or centering pegs, not shown, which are inserted into blind holes.

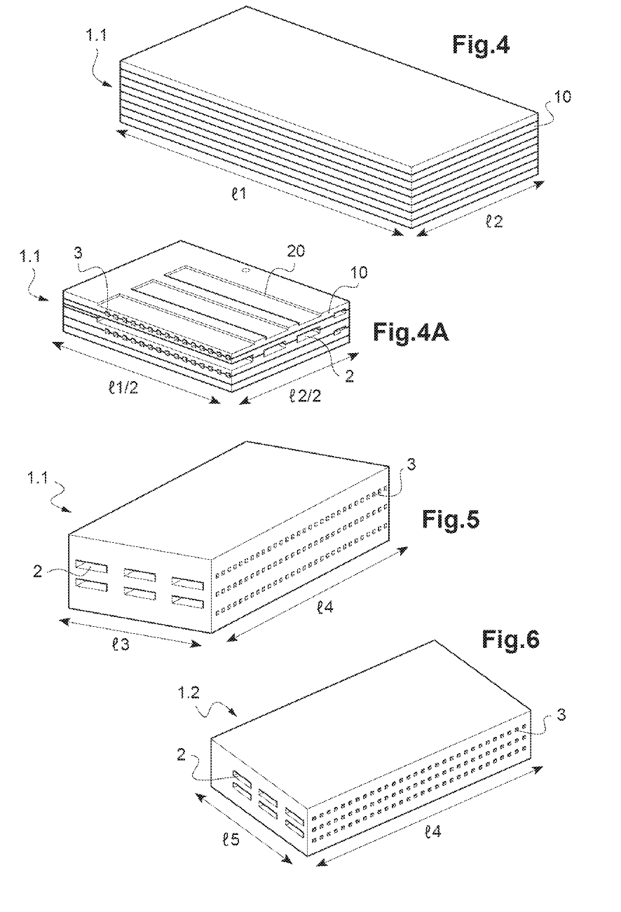

FIGS. 4 and 4A show an example of the stacking to produce an elementary exchanger module 1.1 with a superpositioning of channels 2, 3 of the two fluid circuits C2.

Step iv/: The entire periphery of the stack (block) is rendered tight and each interface is degassed by an emerging orifice, which will be blocked up. To accomplish the sealing at the periphery of the stack, the entire stacking is done in a container.

The container, made of stainless steel sheet folded and welded by the TIG method, is itself cleaned, along with its cover. The cover is welded by TIG to the container and then the container is placed under vacuum by pumping through a tube welded to one of its sides. The tube is then pinched off, sliced, and itself welded to prevent the introduction of air inside the container.

One then subjects the container, and thus the complete stack, to a cycle of low-pressure HIC involving a heating of 900 to 1100° C. for a period of 1 to 4 h under a pressure of 30 to 300 bar, then a cooldown for several hours and a depressurization.

One carries out all of these steps i/ to iv/ for each of the elementary modules 1.1, 1.2, 1.3 which are going to make up the one-piece exchanger according to the invention.

Step b/: for each of the elementary modules 1.1, 1.2, 1.3, one then performs their reduction involving a decreasing of the borders by milling and the opening of the channels 2 and/or 3 by trimming the ends of the stack which are blocking them.

In the example illustrated:

the elementary module 1.1 is machined so as to have a length l4 and a width l3, with all the channels 2, 3 of both the first circuit and the second circuit which have been opened, that is, all of them emerging to the outside (FIG. 5);

the elementary module 1.2 is machined so as to have a length l4 and a width l5, with all the channels 2 of the first circuit, being parallel to the length of the exchanger, which have been opened at their two ends, while the channels 3 of the second circuit parallel to the width of the exchanger have been opened at only one of their ends (FIG. 6);

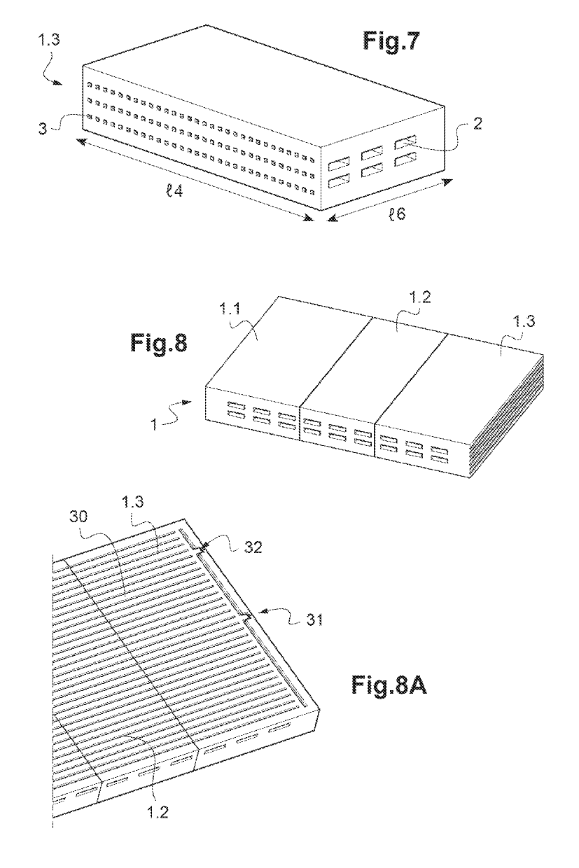

the elementary module 1.3 is machined so as to have a length l4 and a width l6, with all the channels 2 of the first circuit, being parallel to the length of the exchanger, which have been opened at their two ends, while the channels 3 of the second circuit parallel to the width of the exchanger have been opened at only one of their ends (FIG. 7).

Step c/: at the end of the machining of all the elementary modules, they are positioned edge to edge. In the example illustrated, one places side by side the three elementary modules 1.1, 1.2, 1.3 of the same length l4 but different width l3, l5, l6 by their longitudinal edge at the side, in order to form a block 1 of outer dimensions l4×(l3+l5+l6) (FIG. 8).

Step d/: once the edge to edge positioning of the elementary modules 1.1, 1.2, 1.3 has been accomplished, one then performs the assembly of the interfaces of the exchanger so formed. This is advantageously done by means of HIC diffusion bonding. First of all, one cleans the reduced elementary modules with the aid of solvents and detergents.

Next, one performs the sealing of the interfaces by TIG welding, and then places under vacuum the sealed interfaces between the elementary modules and thus also those of the channels communicating with the latter, in order to ensure their continuity from one elementary module to another.

FIG. 8A thus shows the machining 31 (boring) performed in advance and making it possible to interconnect the different zones of channels 3 being welded, as well as the machining 32 making it possible to weld a pip and thus perform the evacuation.

One then performs the tight closing of the pips.

Finally, one applies to the block 1 of elementary modules 1.1, 1.2, 1.3 so obtained a cycle of low-pressure HIC, typically at a pressure between 20 and 500 bar, preferably between 30 and 300 bar. The choice of the pressure results from a compromise between the quality of the welding to be achieved and the acceptable deformation of the channels not opened.

One can subsequently perform one or more machining processes to finish the one-piece heat exchanger 1, in particular, to open the fluid circuit which was left closed.

One can then submit the exchanger to a high-pressure HIC cycle, typically under a pressure between 200 and 2000 bar, preferably between 500 and 1200 bar. During this cycle, one completes the assembly of the plates making up the elementary modules and that of the modules to each other.

One can also add on subsequently, by welding, fluid distribution manifolds, not shown, so as to feed and/or recuperate a fluid in each of the first C1 and second C2 circuits in the area of the ends of the grooves forming the channels 2, 3.

Thanks to the method according to steps a/ to d/, one obtains a one-piece heat exchanger assembled by HIC diffusion bonding which is compact, has large dimensions and/or a large number of channels whose geometrical shape has undergone very little deformation as regards the initial shape produced during the stacking.

Of course, the present invention is not limited to the variants and the embodiments described as an illustration and not a limitation.

In the example illustrated, the elementary exchanger modules are placed laterally side by side. One can also contemplate positioning them edge to edge in the height direction, that is, stacking them one on another. In this case, the two fluid circuits can be opened during the assembly process of the exchanger: the HIC cycle applied can then be a cycle of high pressure type as above. The positioning can also be done in the length direction, that is, placed end to end, following each other in succession, or in several directions at the same time.

In the example illustrated, all the plates making up all of the elementary modules are made of the same material, preferably a stainless steel of type 316L. One can also contemplate having plates of different material within the same elementary module or plates of different material from one elementary module to another.

In the example illustrated, the seals at the interfaces between elementary modules are made by welding. Any other means allowing the production of a seal and maintaining its integrity during the diffusion bonding of the block can be utilized.

The size of the channels for each of the fluid circuits can be different depending on the nature and the properties of the fluids being carried, the allowable head losses, and the desired flow rate. One may stack several elements of the same circuit in order to optimize a functionality of the exchanger, for example the heat transfer or the flow rate of one of the fluids.

While the example illustrated involves exchangers with precisely two fluid circuits, it is quite possible to fabricate an exchanger with three or more fluid circuits, starting from two, three or more elementary exchanger modules.

The two fluid manifolds can be arranged on either side of the exchanger, or alternating on the same side of the exchanger.

The heat exchangers obtained by the method of the invention can be assembled with each other, for example by using flanges or by welding on fluid supply pipelines. One may thus contemplate the production of a heat exchanger system with several exchangers connected to each other, in which the transfers occur in several steps with different mean temperatures or sufficiently reduced temperature differences per module to diminish the thermal stresses in the materials. For example, in the case of a heat exchanger in which one desires to transfer the heat from a first fluid to a second, one can conceive of an exchanger system in which each exchanger enables a decreasing of the temperature of the first fluid by a given value, thus limiting the stresses in regard to a design with a single exchanger having a more elevated temperature difference. For this, the inlet temperature of the second fluid may differ from one module to another. In another example, a reactor exchanger system allows a complex chemical reaction to be carried out in steps by precisely controlling the reaction temperature during each step, for an optimal control of the chemical reaction, a minimization of risks and a maximization of yields.

A system of heat exchangers with several exchangers also makes it possible to reduce the maintenance costs by allowing the individual replacement of a faulty exchanger, and the manufacturing costs by standardization of the exchangers.

1. A method of production of a heat exchanger with at least two fluid circuits each one comprising channels, involving the following steps:
a/ production of at least two elementary modules of the exchanger, the production of each elementary module involving the following steps:
i/ production of one or more elements of one of the two fluid circuits, the so-called first circuit, each element of the first circuit comprising at least one metal plate comprising first grooves forming at least one portion of the channels of the first circuit;
ii/ production of one or more elements of at least one other fluid circuit, the so-called second circuit, each element of the second circuit comprising at least one metal plate comprising second grooves forming at least one portion of the channels of the second circuit;
iii/ stacking of the metal plates of the elements of the first and second circuits in order to form their channels;
iv/ assembling by diffusion bonding of the element or elements of the first circuit and the element or elements of the second circuit, stacked one on the other;
b/ modification of at least one of the elementary modules involving a reduction of the width of at least one of the borders and/or of the thickness of at least one of the anvils of at least one of the modules and optionally an opening of the channels of the first circuit and/or of the second circuit to the outside;
c/ edge to edge positioning of the elementary modules, at least one of which is reduced, along one of their longitudinal edges or one of their lateral edges;
d/ assembling of the interfaces between the edge to edge elementary modules in order to obtain the exchanger in one-piece form.

2. The method as claimed in claim 1, wherein before the stacking step iii/, one performs a step i1/ and ii1/ of cleaning of the plates of each element respectively of the first circuit and second circuit.

3. The method as claimed in claim 1, wherein one performs step iv/ by application of a hot isostatic compression (HIC) cycle at relatively low pressure to the tight and degassed stack of each elementary module.

4. The method as claimed in claim 3, wherein the cycle of HIC per step iv/ is performed at a pressure between 20 and 500 bar, preferably between 30 and 300 bar.

5. The method as claimed in claim 3, wherein the cycle of HIC per step iv/ is performed at a temperature between ambient temperature and 1100° C., preferably between 900 and 1100° C.

6. The method as claimed in claim 1, wherein during step b/ the reduction of the width of at least one of the borders and/or the thickness of at least one of the anvils of at least one of the modules is accomplished by removing the tools by demolding or machining, or by machining part of the nongrooved borders of the plates and/or the anvils.

7. The method as claimed in claim 1, wherein during step b/ the opening of the channels can be accomplished by machining of the ends of the module or a bore opposite to the channels.

8. The method as claimed in claim 1, wherein step c/ of edge to edge positioning consists of a stacking of the elementary modules by the principal faces of the end plates of the modules.

9. The method as claimed in claim 1, wherein step c/ of edge to edge positioning consists of an edge to edge alignment along the length of the elementary modules.

10. The method as claimed in claim 1, wherein step c/ of edge to edge positioning consists of a positioning of a lateral edge of one of the elementary modules against a lateral edge of the other of the elementary modules.

11. The method as claimed in claim 1, wherein step d/ is accomplished by electron beam welding, brazing, or diffusion bonding of the reduced modules between themselves.

12. The method as claimed in claim 11, step d/ consisting of a diffusion bonding with application of at least one hot isostatic compression (HIC) cycle.

13. The method as claimed in claim 12, the diffusion bonding of the reduced elementary modules per step d/ is done during the high-pressure cycle making it possible to finish the welding of the internal interfaces of the elementary modules, step b/ involving an opening of the channels of the first circuit and/or of the second circuit to the outside.

14. The method as claimed in claim 1, an elementary module comprising plates of different materials.

15. The method as claimed in claim 1, wherein the material or materials making up one elementary module are different from that or those of another elementary module.

16. The method as claimed in claim 1, involving a step e/ of final machining to finish the one-piece exchanger.

17. A heat exchanger with at least two fluid circuits obtained according to the method as claimed in claim 1.
